(19) United States
(12) Patent Application Publication
(10) Pub. No.: US 2020/0330999 A1
(43) Pub. Date: Oct. 22, 2020

(54) HIGH PRESSURE GRINDING ROLLER STUD

(71) Applicant: ELEMENT SIX GMBH, BURGHAUN (DE)

(72) Inventors: KARL-GEORG HILDEBRAND, BURGHAUN (DE); BERND HEINRICH RIES, BURGHAUN (DE)

(73) Assignee: ELEMENT SIX GMBH, BURGHAUN (DE)

(21) Appl. No.: 16/754,075

(22) PCT Filed: Dec. 4, 2018
(86) PCT No.: PCT/EP2018/083531

§ 371 Date: Apr. 6, 2020

(30) Foreign Application Priority Data
Dec. 5, 2017 (GB) 1720212.8

(51) Int. Cl. B02C 4/30; B02C 4/28

(52) U.S. Cl. CPC B02C 4/305; B02C 4/02; B02C 4/286

(57) ABSTRACT

This disclosure relates to a high pressure grinding roller stud comprising two materials of different hardness, and a high pressure grinding roller incorporating at least one such stud.

### FIELD OF THE INVENTION

This disclosure relates generally to the field of studs for high pressure grinding rollers. Such rollers are typically used for crushing rocks and minerals.

### BACKGROUND

High pressure grinding roller (HPGR) milling is becoming a popular route for crushing rocks and minerals. As shown in FIG. 1, HPGR apparatus includes a first roller 1 and a second roller 2 with a gap between them. In use, the first and second rollers counter-rotate. A feed of material 3 is allowed to fall from a hopper through a gap between the first and second rollers 1, 2.

The first roller 1 is allowed to move linearly in a direction normal to the direction of the material feed. The first roller is usually biased to a particular position relative to the second roller by springs or hydraulic cylinders.

As the material feed passes through the gap between the first and second rollers 1, 2, compression causes the particles of the feed material 3 to fracture, and the resultant material 4 has a much reduced particle size. The use of counter-rotating rollers 1, 2 allows the particle size reduction to be a continuous operation rather than a batch operation.

The rollers 1, 2 may have a flat surface, but in some examples (such as that shown in FIG. 2) the rollers have a plurality of studs 5 disposed on the surface. Studs have the advantage of increasing the pressure where they contact the feed material and protecting the roller itself. The studs are typically made from a hard material such as cemented tungsten carbide and provide an effective roller surface.

After continuous use for a period of time, the studs show signs of wear. The feed material 3 usually falls through the gap at the middle of the rollers, as shown in FIG. 3. This leads to uneven wear, and the gap between the effective roller surfaces at the middle of the rollers becomes larger than the gap towards the ends of the rollers. The same situation occurs where studs are not used (as shown in FIG. 3, with the gap 6 between the rollers being larger towards the middle). This reduces the efficiency of the rollers. In cases where studs are not used, the entire roller must be replaced. In cases where studs are used, the studs must be either be replaced, or selectively ground down towards the ends of the rollers to ensure that the effective rollers surface becomes flat again. Either way, this is a time-consuming and expensive operation.

### SUMMARY

It is an object of the invention to provide a lower cost option of high pressure grinding roller that uses studs on the roller surface than existing rollers.

According to a first aspect of the invention, there is provided a high pressure grinding roller stud, the stud being cylindrical with a central longitudinal axis, the stud comprising first and second volumetric portions joined at a single planar interface, the interface extending perpendicularly to the central longitudinal axis, the first portion comprising a first material and the second portion comprising a second material, the hardness of the first material being different to the second material.

If the stud as a whole is viewed from a performance perspective, and the material properties selected accordingly, the inventors have recognised that cost savings can be made since the entire stud need not be made from the same material. More specifically, the portion of stud beneath the surface of the roller actually fulfils a different role to the portion of stud above the surface of the roller. The portion of stud above the roller surface requires excellent wear resistance because it comes into contact with the rocks and mineral to be crushed. By contrast, the portion of stud beneath the roller surface requires excellent strength in order to effectively couple the rest of the stud to the roller. The wear resistance is much less important. Since achieving excellent wear resistance can be an expensive process, cost savings can be realised by only including it in the stud where absolutely necessary.

Preferably, the stud further comprises a grinding surface, an attachment end configured to attach to a high pressure grinding roller; and a side wall connecting the grinding surface to the attachment end, wherein the first portion includes the grinding surface, and the second portion includes the attachment end.

Optionally, the hardness of the first portion is higher than the hardness of the second portion.

A Vickers hardness of the first material may be between 900 and 1400 HV30, and a Vickers hardness of the second material may be between 100 and 500 HV30.

Optionally, the first portion comprises cemented metal carbide material and the second portion comprises a steel.

The first and second portions may be provided in the volumetric ratio of 1:1, 2:1, 3:1, 4:1, or 5:1 respectively.

The first and second portions may be brazed together to form the interface.

The attachment end may be configured to attach to the roller by any one of the following techniques: gluing, brazing, press-fitting, shrink fitting, threaded connection and/or mechanical connection.

Optionally, the stud further comprises one or more circumferentially extending recesses provided in the side wall.

According to a second aspect of the invention, there is provided a high pressure grinding roller comprising a cylindrical roller having a circumferential surface, and a plurality of high pressure grinding roller studs in accordance with the first aspect of the invention attached to the circumferential surface.

The roller may comprise a first plurality of high pressure grinding roller studs located at a first location on the circumferential surface and a second plurality of high pressure grinding roller studs located at a second location on the circumferential surface, each stud of the first plurality of high pressure grinding roller studs having first and second portions provided in a first volumetric ratio, each stud of the second plurality of high pressure grinding roller studs having first and second portions provided in a second volumetric ratio, the first and second volumetric ratios being substantially different to each other.

The roller may comprise a third plurality of high pressure grinding roller studs located at a third location on the circumferential surface, each stud of the third plurality of high pressure grinding roller studs having first and second portions provided in a third volumetric ratio, the third volumetric ratio being substantially different form the first and second volumetric ratios.

Each pressure grinding roller stud may be attached to the roller by any one of the following techniques: gluing, brazing, press-fitting, shrink fitting, threaded connection, and mechanical connection.

According to a third aspect of the invention, there is provided a method of manufacturing a high pressure grinding roller in accordance with the second aspect of the invention, the method comprising:

providing a plurality of first and second volumetric portions of high pressure grinding roller studs in a pre-defined volumetric ratio,

joining together the first and second volumetric portions of high pressure grinding roller stud to form an interface, and

attaching the plurality of high pressure grinding roller studs to the circumferential surface of the high pressure grinding roller.

### BRIEF DESCRIPTION OF THE DRAWINGS

The invention will now be more particularly described, by way of example only, with reference to the accompanying drawings, in which

FIG. 1 illustrates schematically a known high pressure grinding roller apparatus;

FIG. 2 shows rollers comprising studs;

FIG. 3 illustrates schematically a plan view of a pair of rollers after use;

FIG. 4 is a side elevation view of a first exemplary high pressure grinding roller stud;

FIG. 5 is a side elevation view of a second exemplary high pressure grinding roller stud;

FIG. 6 is a side elevation view of a third exemplary high pressure grinding roller stud;

FIG. 7 is a side elevation view of a fourth exemplary high pressure grinding roller stud;

FIG. 8 is a schematic cross-section view of a high pressure grinding roller incorporating an exemplary high pressure grinding roller stud;

FIG. 9 is a schematic cross-section view of a high pressure grinding roller incorporating an exemplary high pressure grinding roller stud which includes a circumferentially extending recess; and

FIG. 10 is a schematic cross-section view of the high pressure grinding roller of FIG. 9 showing wear.

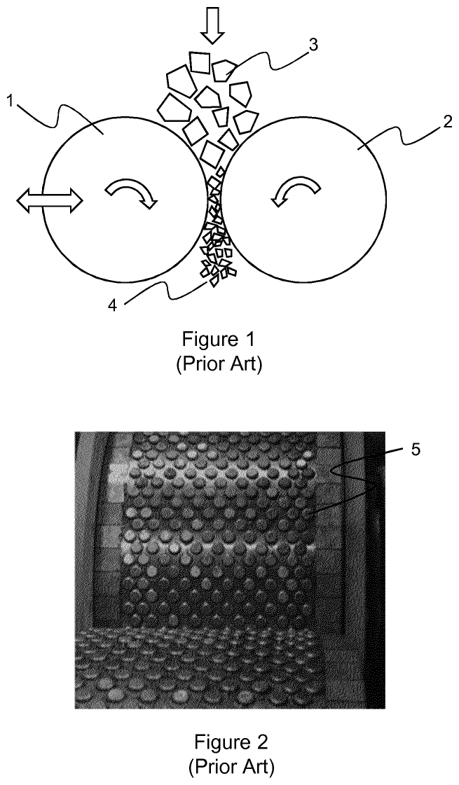

In the drawings, similar parts have been assigned similar reference numerals.

### DETAILED DESCRIPTION

Referring to FIG. 4, a high pressure grinding roller stud 7 is provided. The high pressure grinding roller stud 7 is elongate and has a central longitudinal axis. The high pressure grinding roller stud 7 comprises first and second volumetric portions 17, 18 joined at an interface 19. The interface 19 is planar and extends perpendicularly to the central longitudinal axis.

The first volumetric portion comprises a first material and the second volumetric portion comprises a second material. Preferably, the first volumetric portion consists of a first (bulk) material and the second volumetric portion consists of a second (bulk) material. Wear resistance of the first and second materials is substantially different to each other. Hardness is used as an indirect measure (or proxy) for wear resistance. The first material has a Vickers hardness of 900 to 1400 HV30. The second material has a Vickers hardness of 100 to 500 HV30.

The wear resistance of the first portion is higher than the wear resistance of the second portion. Preferably, the material of the first portion is a cemented metal carbide, and the material of the second portion is a steel. The first portion is preferably a tungsten carbide grade of material with an 8 to 20% cobalt content. The medium grain size in the structure is 2 to 5 μm. The second portion is a standard tool or construction steel.

The stud 7 is substantially cylindrical, and typically circular in axial cross-section. Thus, each first and second volumetric portion 17, 18 is also circular in axial cross-section The length of the stud 7 is typically up to 70 mm. Preferably, the length of each stud is between 20 and 80 mm. More preferably, the length of each stud is between 40 and 70 mm.

The first and second portions 17, 18 are preferably joined at the interface 19 using any one or more of the following techniques: brazing (e.g. silver braze, copper braze, brass braze and the like), gluing (e.g. epoxy, 2 component glue and the like), friction welding, welding, laser welding or threaded connection.

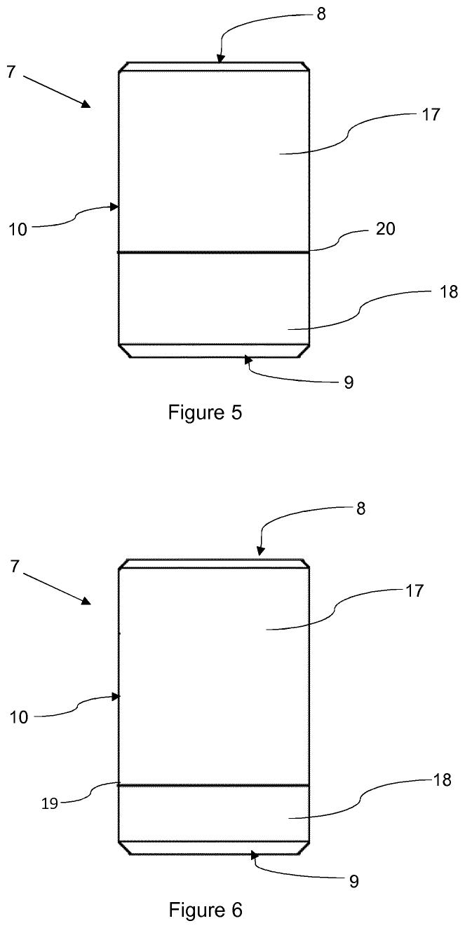

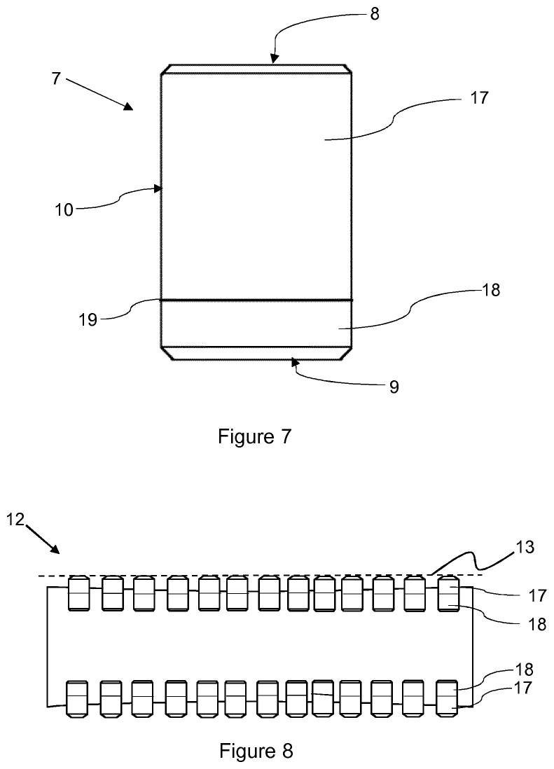

In one embodiment, as indicated in FIG. 4, the volumetric ratio of the first portion 17 to the second portion 18 is approximately 1:1. In another embodiment, as indicated in FIG. 5, the volumetric ratio of the first portion to the second portion is approximately 2:1. Thus, each first and second volumetric portion 17, 18 is cylindrical with two different lengths. In another embodiment, as indicated in FIG. 6, the volumetric ratio of the first portion 17 to the second portion 18 is approximately 3:1. In a further embodiment, as indicated in FIG. 7, the volumetric ratio of the first portion 17 to the second portion 18 is approximately 4:1. The volumetric ratio is influenced by the strength of the joining technique used. For example, with a strongly brazed interface 19, second portion 18 may be made longer than it could be otherwise because it is able to withstand the applied forces during use when the interface 19 of the stud 7 is no longer directly supported within a roller 12. A volumetric ratio of 5:1 is also envisaged.

The stud has a grinding surface 8 arranged to contact the material to be ground. An attachment end 9 is located at an end opposite to the grinding surface 8. The grinding surface 8 and the attachment end 9 are connected by a side wall 10. The first portion 17 includes the grinding surface and the second portion 18 includes the attachment end 9.

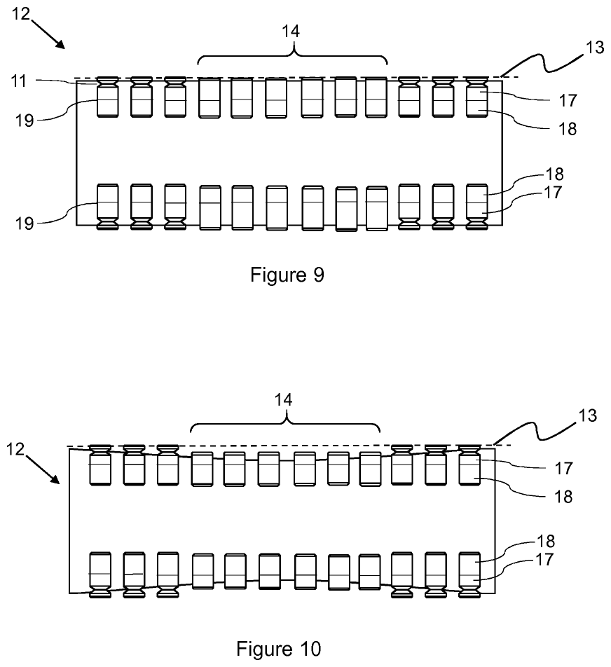

Optionally, as indicated in FIGS. 9 and 10, a circumferential recess 11 may extend around the side wall 10. However, the circumferential recess 11 is not essential to the invention and may be omitted. A recess 11 enables the selective removal of the grinding surface 8 to reveal a fresh grinding surface adjacent the recess when the initial grinding surface is removed.

Turning now to FIG. 8, in use, the stud 7 is attached to a high pressure grinding roller 12 toward the attachment end 9. The stud 7 is received into and seated within a pocket in the surface of the roller 12. Such attachment may be by any suitable means, such as gluing, brazing, shrink fitting, press fitting and so on. A plurality of studs is attached to the grinding roller 12 such that the grinding surface 8 of each stud 7 is at a desired height, and the plurality of grinding surfaces 8 forms an effective roller surface, as indicated in FIG. 8. The effective surface of the roller 12 is indicated by dashed line 13.

Preferably, the proportion of the stud 7 seated below the surface of the grinding roller 12 is at least 80% of the total volume of the stud 7. The proportion of the stud 7 seated below the surface of the grinding roller 12 may be at least 40%, preferably at least 50%, more preferably at least 60% and optionally above 70% of the total volume of the stud 7. This proportion is influenced by the technique used to produce the interface 19.

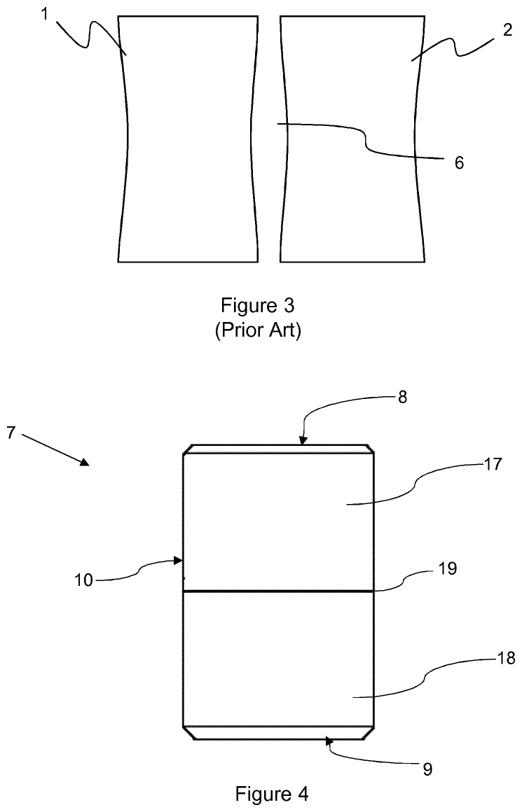

As discussed above, after a period of use, the studs 7 towards the middle of the grinding roller 12 are likely to have been subjected to more wear than the studs 7 towards the ends of the grinding roller, and so the effective grinding surface is no longer flat (or the desired shape profile). This is illustrated in FIG. 9. The studs 14 towards the centre of the roller 12 experience more wear than the studs at either end of the roller 12, and so the effective surface is increasingly no longer flat and gradually resembles the curved surface shown in FIG. 3. In addition to stud wear, the roller 12, which is typically steel, also experiences wear and lower portions of the stud 7 gradually become exposed. Consequently, the interface 19 is preferably located beneath the surface of the roller 19.

It is useful to tailor the ratio of the first and second volumetric portions 17, 18 according to the position of the stud 7 along the length of the roller 12. The studs 7 located towards the centre of the roller 14 may include a greater proportion of first portion 17 to second portion 18 than the studs 7 located towards the ends of the roller 12. For example, the studs 7 towards the centre of the roller 12 may comprise first and second portions 17, 18 in a volumetric ratio of 3:1, whereas the studs 7 located towards the ends of the roller 12 may be present in a volumetric ratio of 1:1 since they will experience less wear.

Note that while the effective roller surface 16 is shown as being substantially flat and parallel to the axis of rotation of the roller 12, a profiled effective grinding surface may be implemented instead.

The invention as set out in the appended claims has been shown and described with reference to embodiments. However, it will be understood by those skilled in the art that various changes in form and detail may be made without departing from the scope of the invention as defined by the appended claims.

For example, other types of material could be used, such as hardened steel, and the stud may have a shape other than cylindrical as described in the examples.

The high pressure grinding roller stud as described herein enables the provision of a lower cost option high pressure grinding roller than what has been previously available.

Furthermore, each composite stud has a better fit in the steel cylinder of the high pressure grinding roller because the portion of the stud in contact with the roller will have a much more closely matched hardness to the steel than a stud with higher wear resistance (and therefore hardness).

The combination of materials in the stud provides a visual indicator of wear marking too, useful as a maintenance control function, enabling operators to better determine when the roller surface needs to be redressed.

Lastly, combination material studs also provide for the higher utilisation of tungsten carbide.

1. A high pressure grinding roller stud, the stud being cylindrical with a central longitudinal axis, the stud comprising first and second volumetric portions joined at a single planar interface, the interface extending perpendicularly to the central longitudinal axis, the first portion comprising a first material and the second portion comprising a second material, the hardness of the first material being different to the second material.

2. A high pressure grinding roller stud as claimed in claim 1, the stud further comprising a grinding surface, an attachment end configured to attach to a high pressure grinding roller; and a side wall connecting the grinding surface to the attachment end, wherein the first portion includes the grinding surface, and the second portion includes the attachment end.

3. A high pressure grinding roller stud as claimed in claim 1, in which the hardness of the first portion is higher than the hardness of the second portion.

4. A high pressure grinding roller stud as claimed in claim 1, in which a Vickers hardness of the first material is between 900 and 1400 HV30, and a Vickers hardness of the second material is between 100 and 500 HV30.

5. A high pressure grinding roller stud as claimed in claim 1, in which the first portion comprises cemented metal carbide material and the second portion comprises a steel.

6. A high pressure grinding roller stud as claimed in claim 1, in which the first and second portions are provided in the volumetric ratio of 1:1, 2:1, 3:1, 4:1, or 5:1 respectively.

7. A high pressure grinding roller stud as claimed in claim 1, in which the first and second portions are brazed together to form the interface.

8. A high pressure grinding roller stud as claimed in claim 2, in which the attachment end is configured to attach to the roller by any one of the following techniques: gluing, brazing, press-fitting, shrink fitting, threaded connection and/or mechanical connection.

9. A high pressure grinding roller stud as claimed in claim 2, further comprising one or more circumferentially extending recesses provided in the side wall.

10. A high pressure grinding roller comprising a cylindrical roller having a circumferential surface, and a plurality of high pressure grinding roller studs as claimed in claim 1 attached to the circumferential surface.

11. A high pressure grinding roller as claimed in claim 10, comprising a first plurality of high pressure grinding roller studs located at a first location on the circumferential surface and a second plurality of high pressure grinding roller studs located at a second location on the circumferential surface,
each stud of the first plurality of high pressure grinding roller studs having first and second portions provided in a first volumetric ratio,
each stud of the second plurality of high pressure grinding roller studs having first and second portions provided in a second volumetric ratio,
the first and second volumetric ratios being substantially different to each other.

12. A high pressure grinding roller as claimed in claim 10, comprising a third plurality of high pressure grinding roller studs located at a third location on the circumferential surface,
each stud of the third plurality of high pressure grinding roller studs having first and second portions provided in a third volumetric ratio,
the third volumetric ratio being substantially different form the first and second volumetric ratios.

13. A high pressure grinding roller as claimed in claim 10, wherein each pressure grinding roller stud is attached to the roller by any one of the following techniques: gluing, brazing, press-fitting, shrink fitting, threaded connection, and mechanical connection.

14. A method of manufacturing a high pressure grinding roller as claimed in claim 10, the method comprising:
providing a plurality of first and second volumetric portions of high pressure grinding roller studs in a pre-defined volumetric ratio,
joining together the first and second volumetric portions of high pressure grinding roller stud to form an interface, and
attaching the plurality of high pressure grinding roller studs to the circumferential surface of the high pressure grinding roller.
